(19) United States
(12) Patent Application Publication
(10) Pub. No.: US 2010/0289910 A1
(43) Pub. Date: Nov. 18, 2010

(54) METHOD AND APPARATUS FOR REMOTE CAMERA CONTROL

(75) Inventor: Artem Vladimirovich Kamshilin, Houston, TX (US)

Correspondence Address: HESLIN ROTHENBERG FARLEY & MESITI PC, 5 COLUMBIA CIRCLE, ALBANY, NY, 12203, US

(73) Assignee: MORAN RESEARCH AND CONSULTING, INC., Houston, TX (US)

(21) Appl. No.: 12/466,967

(22) Filed: May 15, 2009

(51) Int. Cl. H04N 5/232

(52) U.S. Cl. 348/211.4; 348/E05.042

(57) ABSTRACT

A method for remotely controlling a camera is disclosed. One or more first control signals having a first protocol are externally sent to a first interface of a camera. One or more second control signals having a second protocol are externally sent to a second interface of the camera different from the first interface. The one or more first control signals and the one or more second control signals are coordinated to effect control of at least one exposure function of the camera. An apparatus for remotely controlling a camera is also disclosed.

### FIELD

The claimed invention generally relates to cameras and more specifically to a method and apparatus for remote camera control.

### BACKGROUND

With the proliferation of cameras having electronics, many cameras have on-board selectable features for choosing a desired exposure mode and/or shutter speed. Such features are usually selectable by using a combination of on-board camera menus and manually settable buttons or switches. For the casual photographer, this on-board functionality and control provided by most cameras may suffice for everyday picture taking needs. Photography enthusiasts and professionals, however, often find it desirable to modify exposure and shutter settings to values which are not necessarily included in a pre-set mode available on the camera. Unfortunately, some cameras are not equipped with a user interface which allows photography enthusiasts to modify exposure or shutter speed settings beyond a particular set of presets. Even more robust cameras, which are outfitted with menus to adjust various exposure and shutter settings beyond the presets can be cumbersome to use. Furthermore, even if a camera has a well-laid-out menu for making these setting adjustments, it may not be practical to utilize the menu once a camera has been mounted to a tripod and sighted on a particular scene since manipulation of the camera menu buttons is likely to shift the aim of the camera, causing unwanted framing, potentially undesirable photos, and delays for having to reset camera scenes. In the case of action-oriented scenes it may not even be possible to obtain another chance at a particular shot if the event has passed.

As a result of such concerns, some camera manufacturers have been providing a remote interface to control certain features of their cameras remotely, for example via a universal serial bus (USB) control cable. Using a USB-enabled camera, and loading software from the manufacturer onto a computer, the camera can be connected via USB to the computer and the camera settings can be remotely adjusted on the computer without disturbing the camera. Some manufacturers have even designed their USB interface to allow the remote computer to activate the shutter release sequence, thereby initiating the taking of a photograph. While this hands-free approach enables photographers to avoid disturbing their tripods, the shutter release sequence often is delayed due to the need to serially process all of the setting commands as well as inherent delays in the USB protocol. As a result, while the use of a computer coupled to a camera for remote control of exposure and shutter speed may provide convenient hands-free operation of the camera, it does not provide the type of shutter release control and shutter response necessary for many photographers' needs.

Many camera's provide a second control interface beyond the computer control interface for control of the camera's shutter. By connecting a “bulb” controller (second device) to the shutter control interface, the shutter release sequence can be initiated by the bulb separately from the remote. Unfortunately, the photographer, while only having the basic ability to initiate the shutter release sequence with the second device, still is required to have a high degree of user intervention to prepare the camera for use, not to mention the extra equipment which must be carried to photo sites.

Therefore, it would be very desirable to have a single, economical, easily portable, handheld apparatus and method for remotely controlling a camera such that auxiliary camera functions may be controlled in a coordinated fashion with shutter functions, including advanced shutter functions beyond direct shutter control.

### SUMMARY

A method for remotely controlling a camera is disclosed. One or more first control signals having a first protocol are externally sent to a first interface of a camera. One or more second control signals having a second protocol are externally sent to a second interface of the camera different from the first interface. The one or more first control signals and the one or more second control signals are coordinated to effect control of at least one exposure function of the camera.

An apparatus for remotely controlling a camera is also disclosed. The apparatus has an external camera controller. The external camera controller is adapted to output one or more first control signals having a first protocol to a first interface of a camera. The external camera controller is also adapted to output one or more second control signals having a second protocol to a second interface of the camera different from the first interface. The external camera controller is further adapted to coordinate the one or more first control signals and the one or more second control signals to effect control of at least one exposure function of the camera.

A computer program product for remotely controlling a camera is also disclosed. The computer program product comprises a storage medium readable by a processing circuit and stores instructions for execution by the processing circuit for performing a method of remotely controlling a camera. The executable instructions are for externally sending one or more first control signals having a first protocol to a first interface of a camera. The executable instructions are also for externally sending one or more second control signals having a second protocol to a second interface of the camera different from the first interface. The executable instructions are further for coordinating the one or more first control signals and the one or more second control signals to effect control of at least one exposure function of the camera.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the claimed invention are apparent from the following detailed description taken in conjunction with the accompanying drawings in which:

FIG. 1 illustrates one embodiment of a method for remotely controlling a camera.

FIG. 2 illustrates embodiments of one or more actions which may be taken to utilize at least one auxiliary camera function control with one or more first control signals as part of a method for remotely controlling a camera.

FIG. 3 illustrates embodiments of one or more actions which may be taken to control at least one shutter function with one or more second control signals as part of a method for remotely controlling a camera.

FIG. 4A schematically illustrates one embodiment of a method for remotely controlling a camera in a single shot mode.

FIG. 4B schematically illustrates one embodiment of a method for remotely controlling a camera in a time lapse mode.

FIG. 4C schematically illustrates one embodiment of a method for remotely controlling a camera in a high dynamic range mode.

FIG. 5 schematically illustrates one embodiment of an apparatus for remotely controlling a camera.

FIG. 6 schematically illustrates another embodiment of an apparatus for remotely controlling a camera.

FIG. 7 schematically illustrates one embodiment of a system for remote camera control.

FIG. 8 schematically illustrates one embodiment of a preparation workflow as part of a method for remotely controlling a camera.

FIG. 9 schematically illustrates another embodiment of a method for remotely controlling a camera.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

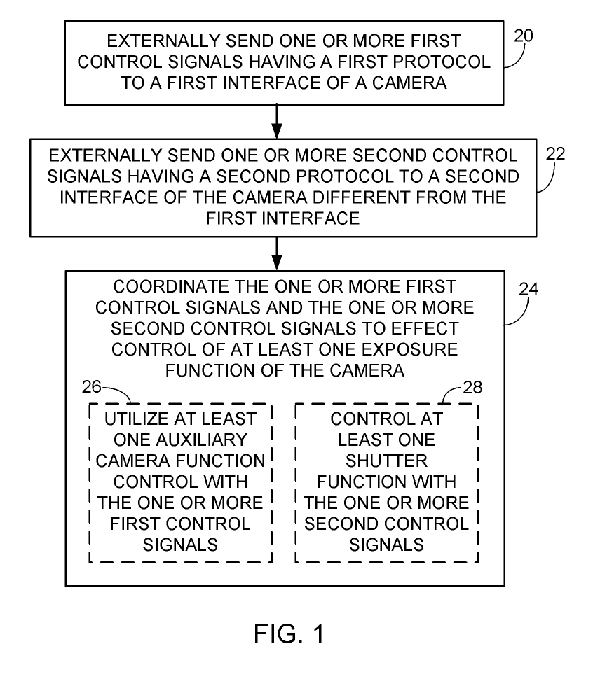

FIG. 1 illustrates one embodiment of a method for remotely controlling a camera. One or more first control signals having a first protocol are externally sent 20 to a first interface of a camera. The first protocol may include one or more commands recognizable by the camera which can cause the camera to report a set-point or a status, cause the camera to change a particular camera setting, or initiate an action on the camera. The first protocol may also be a layered protocol, whereby the camera commands are further wrapped in one or more other protocols for transport. Suitable non-limiting examples of the first interface of the camera may include USB, IEEE 1394, serial, Bluetooth, 802.11x, digital control line, analog control line, and IrDA physical layer connections. The first interface of the camera may be a wired or wireless interface and is used by the camera to allow access to one or more remote auxiliary functions of the camera.

One or more second control signals having a second protocol are externally sent 22 to a second interface of the camera. The second protocol may include one or more commands or activateable signal lines recognizable by the camera which can control at least one shutter function. Depending on the embodiment, the second protocol may be the same protocol as the first protocol or it can be different. The second protocol may also be a layered protocol, whereby the camera commands are further wrapped in one or more other protocols for transport. Suitable non-limiting examples of the second interface of the camera may include USB, IEEE 1394, serial, Bluetooth, 802.11x, digital control line, analog control line, and IrDA physical layer connections.

The one or more first control signals and the one or more second control signals are coordinated 24, preferably by an external camera controller, to effect control of at least one exposure function of the camera. One way to effect control of the at least one exposure function of the camera is to coordinate 24 the first and second control signals such that at least one auxiliary camera function is utilized 26 in with the one or more first control signals in conjunction with and at least one shutter control function being controlled 28 with the one or more second control signals. As will be discussed in further embodiments, the coordination of the first and second control signals can be such that the timing of the first and second control signals is interdependent at one or more points, performed independently at some points, and optionally performed in parallel at one or more points.

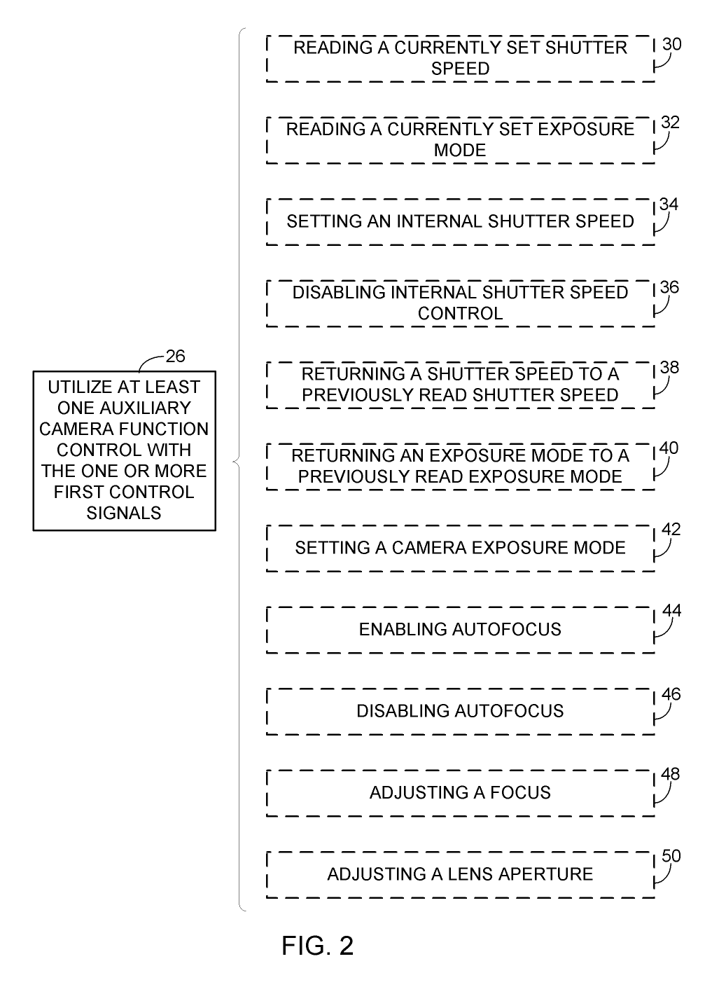

FIG. 2 illustrates embodiments of one or more actions which may be taken to utilize 26 at least one auxiliary camera function control with one or more first control signals as part of a method for remotely controlling a camera. A currently set shutter speed may be read 30 from the camera and reported back to the external camera controller. A currently set exposure mode may be read 32 from the camera and reported back to the external camera controller. An internal shutter speed may be set 34. An internal shutter speed control may be disabled 36. (This is sometimes referred to as entering “bulb” mode by photographers.) A shutter speed can be returned 38 to a previously read shutter speed. An exposure mode can be returned 40 to a previously read exposure mode. A camera exposure mode can be set 42. Autofocus can be enabled 44 or disabled 46. A focus may be adjusted 48, and/or a lens aperture may be adjusted 50. When the auxiliary camera function utilized directs the camera to take a particular action or change a particular setting, the camera may optionally report back a completion status for the action, depending on the first protocol being used. Protocols which report status may be useful in assisting the external camera controller to coordinate the first and second control signals.

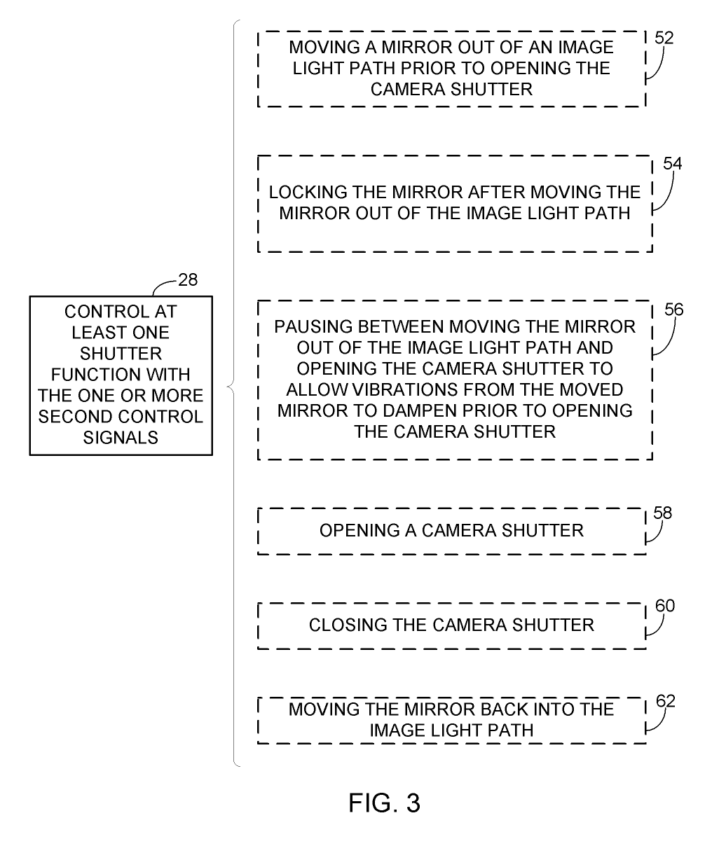

FIG. 3 illustrates embodiments of one or more actions which may be taken to control 28 at least one shutter function with one or more second control signals as part of a method for remotely controlling a camera. Some cameras, such as single lens reflex (SLR) cameras have a mirror moveably disposed in an image light path of the camera. Since the image light path is designed to focus an image on an image recording object, such as a digital image sensor or traditional film, the moveable mirror, when in the image light path (home position for the mirror) reflects the image to be captured to a viewfinder for the photographer to examine prior to taking the picture. In order to take the picture, the mirror first needs to be moved out of the image light path. When controlling 28 at least one shutter function with one or more second control signals as part of a method for remotely controlling a camera, the external camera controller may optionally move 52 the mirror out of the image light path prior to opening the camera shutter. By providing for more than just direct control of the camera shutter (for example, by providing for control related to this SLR mirror operation), a variety of further advantages become possible as part of the coordination process between the first and second control signals. For example, the mirror may optionally be locked 54 after it is moved out of the image light path. The movement of the mirror causes vibrations which can oscillate within the camera and degrade image quality. By locking the mirror, the vibrations may be dampened, resulting in better image quality. Alternatively or additionally, a pause may be taken 56 between moving the mirror out of the image light path and opening the camera shutter to allow vibrations from the moved mirror to dampen prior to opening the camera shutter. The camera shutter may be opened 58. Thus, the shutter may be kept open for any desired duration, including, for example, durations of longer than 30 seconds which are the limit for many current cameras, although the shutter may be kept open for any desired duration. The camera shutter may be closed 60. The mirror may also be moved back 62 into the image light path.

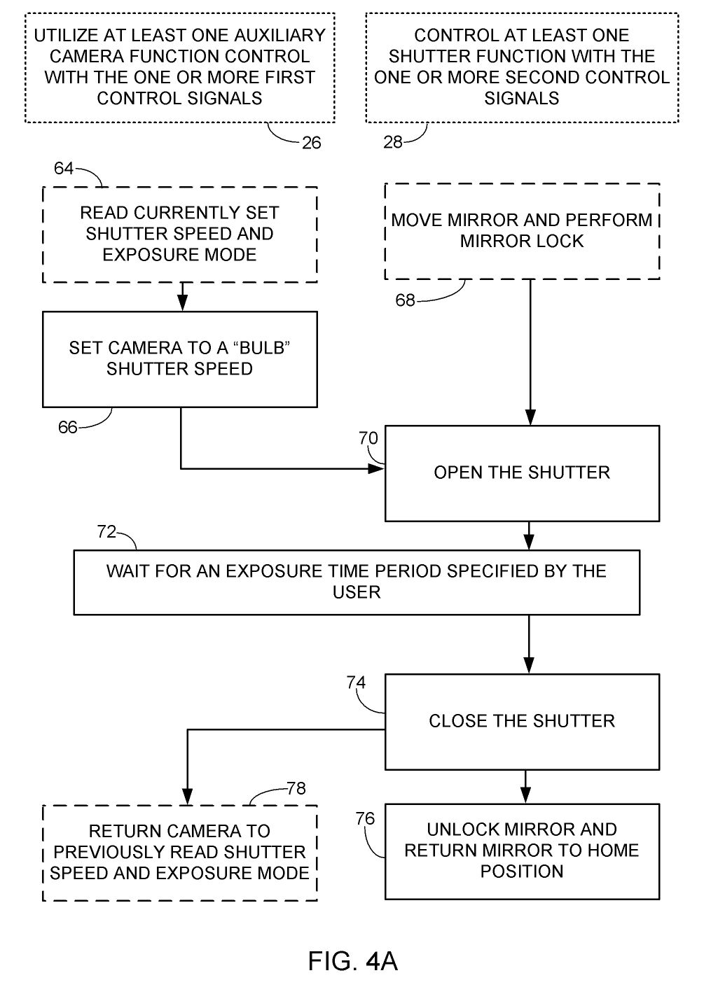

FIG. 4A schematically illustrates one embodiment of a method for remotely controlling a camera in a single shot exposure function mode. Actions which are used to utilize 26 at least one auxiliary camera function control with the one or more first control signals are illustrated in the left column. Actions which are used to control 28 at least one shutter function with the one or more second control signals are illustrated in the right column. Actions which may take place externally on the external camera controller but which do not necessarily have to involve the first or second interfaces are centered between the left and right columns. Current settings for the camera shutter speed and exposure mode may optionally be read 64 from the camera using the first interface. The camera is set 66 to a “bulb” shutter speed, using the first interface, thereby allowing the shutter to stay open for as long as externally controlled. In cameras which provide separate control over the mirror movement as part of the shutter functions, the mirror may be moved and locked 68, using the second interface, for improved image quality. Once the camera is set 66 to a “bulb” shutter speed, the shutter may be opened 70 using the second interface. A desired exposure time, specified by the user, is then waited-for 72. The desired exposure time could be pre-set into the external camera controller or it could be manually controlled by the user via a user interface coupled to the external camera controller which is coordinating the one or more first control signals and the one or more second control signals to effect control of the at least one exposure function of the camera. The shutter may be closed 74 using the second interface. The mirror may be unlocked and returned 76 to its home position. Optionally, the camera may be returned 78 to the previously read shutter speed and exposure mode.

FIG. 4B schematically illustrates one embodiment of a method for remotely controlling a camera in a time lapse exposure function mode. Actions which are used to utilize 26 at least one auxiliary camera function control with the one or more first control signals are illustrated in the left column. Actions which are used to control 28 at least one shutter function with the one or more second control signals are illustrated in the right column. Actions which may take place externally on the external camera controller but which do not necessarily have to involve the first or second interfaces are centered between the left and right columns. Current settings for the camera shutter speed and exposure mode may optionally be read 80 from the camera using the first interface. The camera is set 82 to a “bulb” shutter speed, using the first interface, thereby allowing the shutter to stay open for as long as externally controlled. In cameras which provide separate control over the mirror movement as part of the shutter functions, the mirror may be moved and locked 84, using the second interface, for improved image quality. Once the camera is set 82 to a “bulb” shutter speed, the shutter may be opened 86 using the second interface. A desired exposure time, specified by the user, is then waited-for 88. As described above, the desired exposure time could be pre-set into the external camera controller or it could be manually controlled by the user via a user interface coupled to the external camera controller which is coordinating the one or more first control signals and the one or more second control signals to effect control of the at least one exposure function of the camera. The shutter may be closed 90 using the second interface. A desired time lapse period, specified by the user, is then waited-for 92. The desired time lapse period could be pre-set into the external camera controller or it could be manually controlled by the user via the user interface coupled to the external camera controller. The external camera controller decides 94 if more images should be taken as part of the time lapse series. This decision 94 may be based on a preset number of images selected by a user for the time lapse series, or the decision may be based on an elapsed time or end time. For example, a user may specify time lapse photos to be taken every 20 seconds for the next 10 minutes or that time lapse photos should be taken from initiation of the sequence through a chosen end-time. If more images should be taken 96, then the process may be repeated from the opening of the shutter 86. If no more images should be taken 98, then the mirror may be unlocked and returned 100 to its home position. Optionally, the camera may be returned 102 to the previously read shutter speed and exposure mode.

FIG. 4C schematically illustrates one embodiment of a method for remotely controlling a camera in a high dynamic range exposure function mode. Actions which are used to utilize 26 at least one auxiliary camera function control with the one or more first control signals are illustrated in the left column. Actions which are used to control 28 at least one shutter function with the one or more second control signals are illustrated in the right column. Actions which may take place externally on the external camera controller but which do not necessarily have to involve the first or second interfaces are centered between the left and right columns. An exposure sequence may be calculated 104 from user-specified parameters. As a first non-limiting example, a low exposure time and a high exposure time may be specified by a user along with a desired number of exposure steps. The external camera controller can divide the difference between the high and low exposure times by the desired number of exposure steps to determine an exposure increment. Then, an exposure sequence can be determined, starting from the low exposure time, increasing by the exposure increment for each step in the exposure sequence, until the high exposure time is reached. As a second non-limiting example, a middle exposure, an exposure increment value, and a number of increments may be specified by a user. The exposure sequence may be calculated for a number of exposure steps (equal to the specified number of increments) backwards and forwards from the specified middle exposure, each exposure step moving a specified exposure increment further in a lower and higher direction from the specified midpoint. The exposure increment value need not be fixed and may even be specified for each exposure step or specified to vary as a function based on one or more parameters such as the exposure step number, the middle exposure value, and/or the distance from the middle exposure value. In other embodiments, the user may optionally specify a non-symmetrical exposure bracket around the exposure midpoint. In still other embodiments, the calculation of the exposure sequence may also allow a user to specify a fixed or variable time lapse between exposures in the exposure sequence.

Current settings for the camera shutter speed and exposure mode may optionally be read 106 from the camera using the first interface. The camera is set 108 to a shutter speed from step 1 to N in the exposure sequence specified by the user. In cameras which provide separate control over the mirror movement as part of the shutter functions, the mirror may be moved and locked 110, using the second interface, for improved image quality. Once the camera shutter speed is set for the step in the exposure sequence, the shutter may be opened 112 using the second interface. A desired exposure time, specified by the user, is then waited-for 114. As described above, the desired exposure time could be pre-set into the external camera controller or it could be manually controlled by the user via a user interface coupled to the external camera controller which is coordinating the one or more first control signals and the one or more second control signals to effect control of the at least one exposure function of the camera. The shutter may be closed 116 using the second interface. The external camera controller may wait 118 for the camera to become available again. This wait time could be a preset value programmed into the external camera controller which allows the camera enough recovery time or the external camera controller could poll the camera on the first interface or the second interface to see if the camera is available. The external camera controller decides 120 if more images should be taken as part of the exposure series. This decision 120 may be based on the number of steps N in the calculated exposure sequence. If more images should be taken 122, then the process may be repeated from the setting of the shutter speed 106. If no more images should be taken 124, then the mirror may be unlocked and returned 126 to its home position. Optionally, the camera may be returned 128 to the previously read shutter speed and exposure mode.

Although example exposure functions for a camera have been illustrated above with the one shot exposure function of FIG. 4A, the time lapse exposure function of FIG. 4B, and the high dynamic range exposure function of FIG. 4C, it should be apparent to those skilled in the art that many other combinations or coordinated first and second control signals may be used to produce other variations for similar exposure functions or to produce entirely different exposure functions. Such flexibility and coordination from a single external camera controller are one of the advantages of the disclosed method, system, and their equivalents.

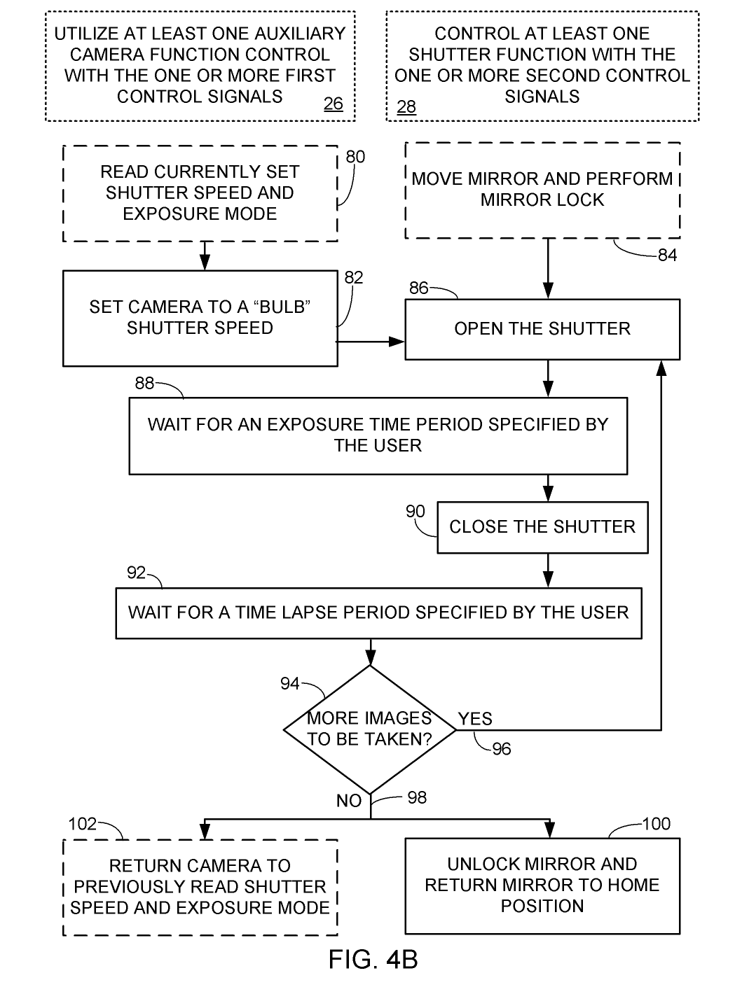

FIG. 5 schematically illustrates one embodiment of an apparatus 130 for remotely controlling a camera. The apparatus 130 has an external camera controller 132 which is adapted to output one or more first control signals having a first protocol to a first interface of a camera. The external camera controller 132 may be a processor, an application specific integrated circuit (ASIC), digital circuitry, analog circuitry, or any combination and/or plurality thereof. The apparatus 130 may have a first interface 134 and a second interface 136 coupled to the external camera controller 132 which may be removably linked (by wire or wirelessly) to the camera so that the external camera controller 132 may coordinate the one or more first control signals and the one or more second control signals to effect control of at least one exposure function of the camera as discussed in the methods above. The apparatus 130 may optionally have a user interface 138 coupled to the external camera controller 132. The user interface 138 may be configured to enable a user to control, program, and/or initiate functions of the apparatus 130 for remotely controlling the camera. The user interface 138 may include a display 140 for providing visual feedback about apparatus 130 functionality and current modes and/or settings. The user interface 138 may include a user input device 142, such as a keypad, for user input and navigation. In some embodiments, the user interface 138 may also provide a sound generator 144 for confirming user actions and/or signaling various operating conditions such as sequence completion or an operation exception. The apparatus 130 may optionally have a sensor interface 146 coupled to the external camera controller 132. The sensor interface 146 may be configured to receive signals from external sensors. The sensor signals may be used as triggers to initiate a portion or all of the coordinated first and second control signals. The sensor signals may also be used to determine auxiliary camera functions and/or shutter functions which may be dependent on the sensor measurement. The external camera controller may also be coupled to a storage medium 148. The storage medium 148 may be permanently or removably installed in the apparatus 130. The storage medium 148 may be an optical disk, a magnetic storage medium, a read-only memory (ROM), a randomly accessible memory (RAM), or a memory card. The storage medium is readable by the external camera controller for performing a method of remotely controlling a camera as discussed above.

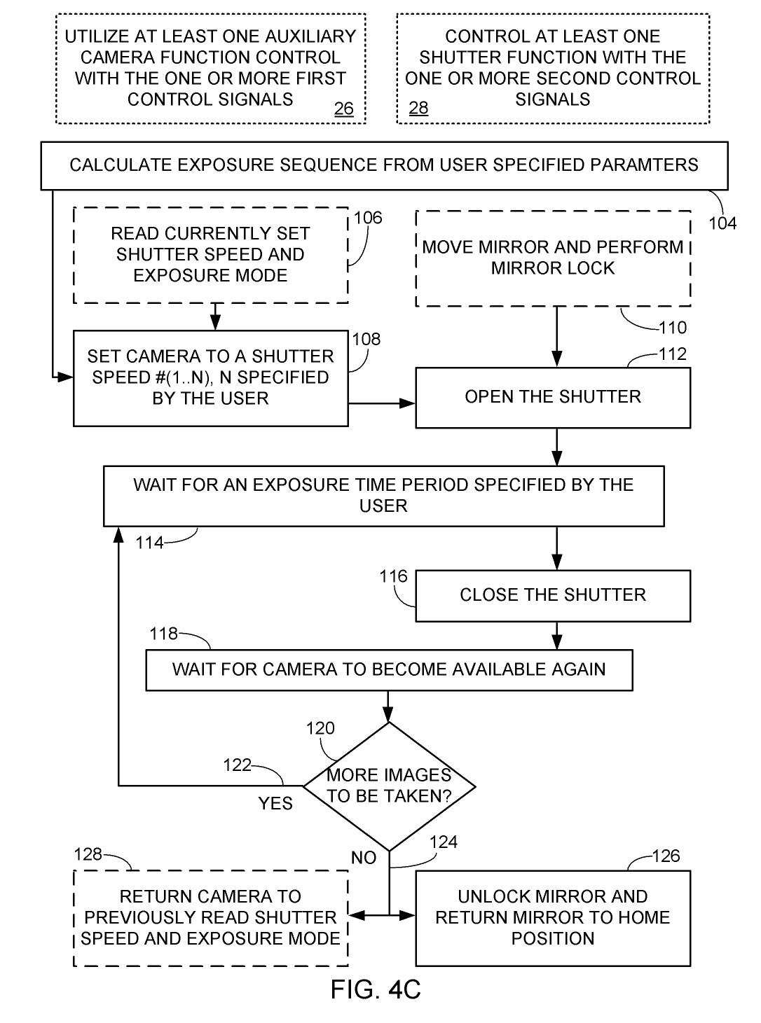

FIG. 6 schematically illustrates another embodiment of an apparatus 150 for remotely controlling a camera. The apparatus 150 is conveniently handheld and has a display 152, a user input device 154, a first interface 156, a second interface 158, and a sensor interface 160 coupled to an external camera controller (not shown, but located internal to the apparatus 150 for remotely controlling the camera.)

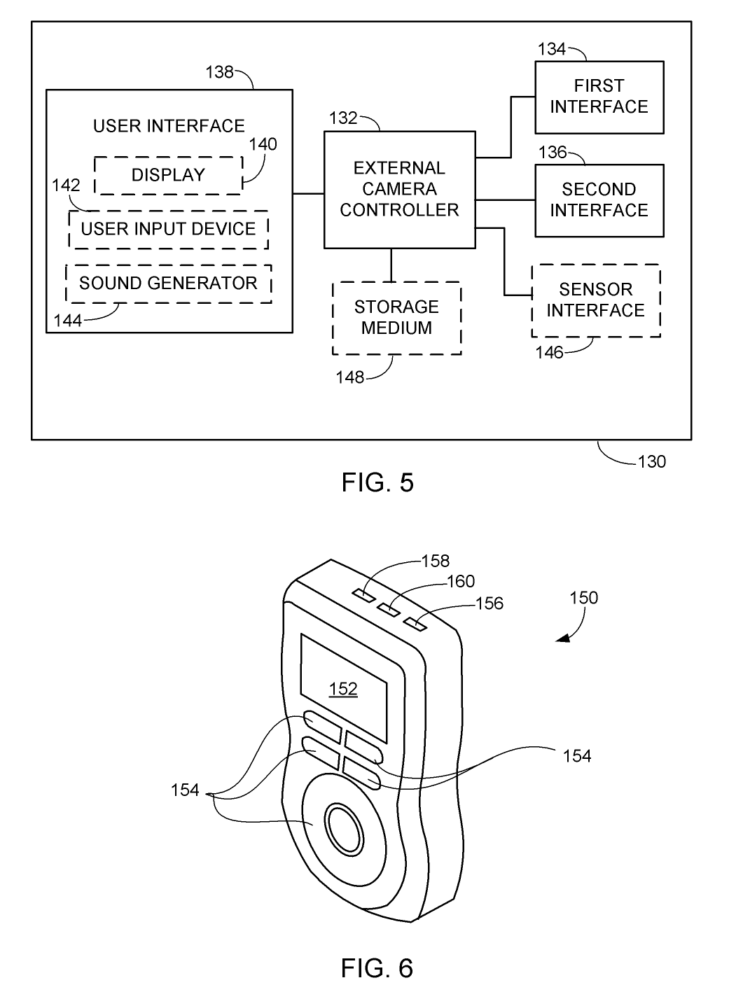

FIG. 7 schematically illustrates one embodiment of a system 162 for remote camera control. The system 162 has a remote control camera apparatus 164, the features of which have been discussed above. The remote control camera apparatus 164 is coupled to a camera 166 via a first interface 168 and a second interface 170. Although the first and second interfaces 168, 170 are illustrated as separate lines in FIG. 7, the actual coupling for the first and second interfaces could be contained within a single cable connectable to a single port on each device 156, 166. In other embodiments, separate ports may be provided on each device 164, 166, one each for the first interface 168 and the second interface 170. Furthermore, the coupling between the remote control camera apparatus 164 and the camera 166 for the first and second interfaces 168, 170 may be wired, wireless, or a combination thereof. Wireless connections may be optical, for example infrared, or they may be radio frequency (RF) communications, for example Bluetooth or 802.11x. Wired connections may also be optical, for example fiber optic, or they may be conductor-based connections.

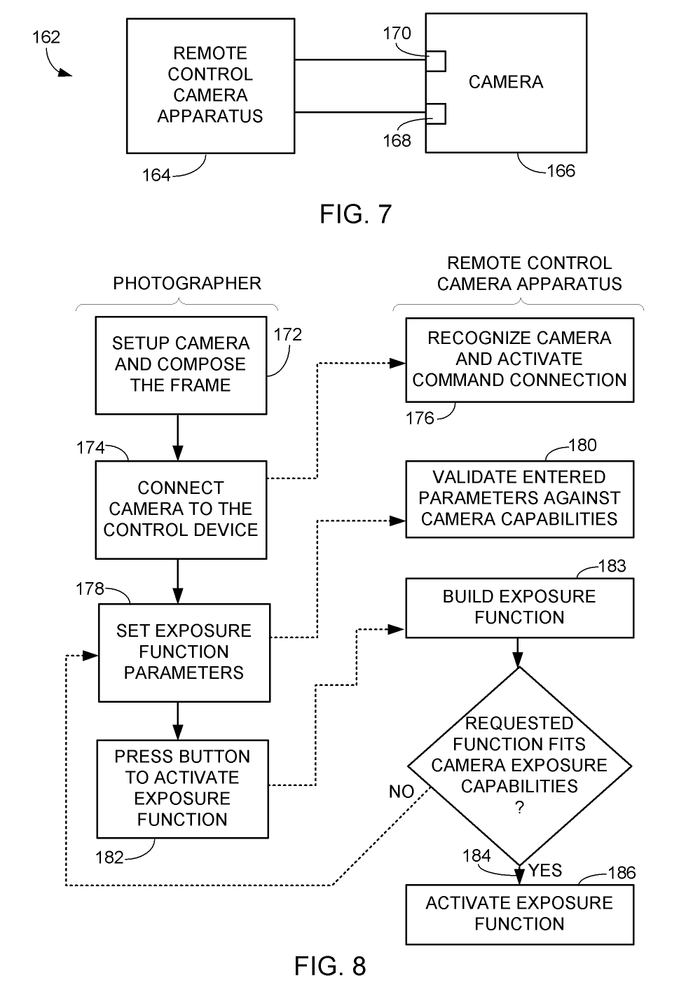

FIG. 8 schematically illustrates one embodiment of a preparation workflow as part of a method for remotely controlling a camera. A photographer sets up the camera and composes 172 the frame. The camera is connected 174 to a remote control camera apparatus, such as the embodiments disclosed above and their equivalents. The remote control camera apparatus recognizes the camera and may activate 176 a command connection. The photographer may set 178 exposure function parameters. The remote control camera apparatus may validate 180 entered parameters against camera capabilities. The photographer can press a button 182 to activate the exposure function. The remote control camera apparatus may build the exposure function. If the requested exposure function fits the camera exposure capabilities 184, then the remote control camera apparatus can activate 186 the exposure function.

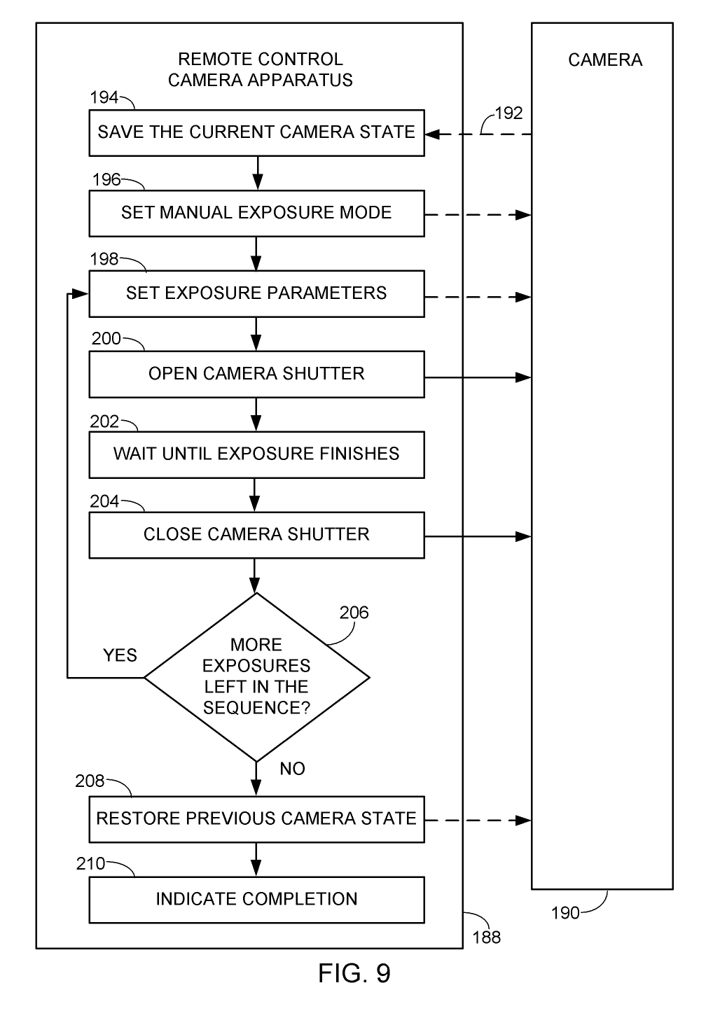

FIG. 9 schematically illustrates another embodiment of an exposure function being controlled by the coordination of one or more first control signals and one or more second control signals as described above as part of a method for remotely controlling a camera. As previously described, the first control signals are communicated with a first interface of a camera and the second control signals are communicated with a second interface of the camera. In this embodiment, the first interface of the camera is a command interface, such as a USB interface, while the second interface of the camera is a shutter activation interface. The command interface communications between the remote control camera apparatus 188 and the camera 190 are illustrated as dashed lines, while the shutter activation communications between the remote control camera apparatus 188 and the camera 190 are illustrated as solid lines. The remote control apparatus 188 receives 192 the current camera state from the camera 190 and saves 194 the current camera state. The remote control apparatus 188 sets 196 a manual exposure mode on the camera 190. The remote control apparatus 188 sets 198 exposure parameters on the camera 190. The remote control apparatus 188 opens 200 the camera shutter. The remote control apparatus 188 waits 202 until exposure finishes and then closes 204 the camera shutter. The remote control apparatus 188 determines 206 if there are more exposures left in the exposure function sequence. If there are more exposures left, the remote control apparatus 188 returns to step 198. If there are no more exposures left, the remote control apparatus 188 restores 208 the previous camera state. The remote control apparatus 188 then indicates 210 completion of the exposure function.

Having thus described several embodiments of a method and apparatus for remote camera control, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

1. A method for remotely controlling a camera, comprising:
externally sending one or more first control signals having a first protocol to a first interface of a camera;
externally sending one or more second control signals having a second protocol to a second interface of the camera different from the first interface; and
coordinating the one or more first control signals and the one or more second control signals to effect control of at least one exposure function of the camera.

2. The method of claim 1, wherein the first protocol is different from the second protocol.

3. The method of claim 1, wherein:
the first interface comprises a universal serial bus (USB) interface; and
the second interface comprises a shutter control interface.

4. The method of claim 1, wherein coordinating the one or more first control signals and the one or more second control signals to effect control of at least one exposure function of the camera comprises:
utilizing at least one auxiliary camera function control with the one or more first control signals; and
controlling at least one shutter function with the one or more second control signals.

5. The method of claim 4, wherein the at least one auxiliary camera function utilized with the one or more first control signals comprises at least one:
reading a currently set shutter speed;
reading a currently set exposure mode;
setting an internal shutter speed;
disabling internal shutter speed control;
returning a shutter speed to a previously read shutter speed;
returning an exposure mode to a previously read exposure mode;
setting a camera exposure mode;
enabling autofocus;
disabling autofocus;
adjusting a focus; and
adjusting a lens aperture.

6. The method of claim 4, wherein the at least one shutter function controlled with the one or more second control signals comprises opening a camera shutter.

7. The method of claim 6, wherein the at least one shutter function controlled with the one or more second control signals further comprises moving a mirror out of an image light path prior to opening the camera shutter.

8. The method of claim 7, wherein the at least one shutter function controlled with the one or more second control signals further comprises locking the mirror after moving the mirror out of the image light path.

9. The method of claim 7, wherein the at least one shutter function controlled with the one or more second control signals further comprises pausing between moving the mirror out of the image light path and opening the camera shutter to allow vibrations from the moved mirror to dampen prior to opening the camera shutter.

10. The method of claim 6, wherein the at least one shutter function controlled with the one or more second control signals further comprises closing the camera shutter.

11. The method of claim 10, wherein the at least one shutter function controlled with the one or more second control signals further comprises moving the mirror back into the image light path.

12. An apparatus for remotely controlling a camera, comprising an external camera controller adapted to:
output one or more first control signals having a first protocol to a first interface of a camera;
output one or more second control signals having a second protocol to a second interface of the camera different from the first interface; and
coordinate the one or more first control signals and the one or more second control signals to effect control of at least one exposure function of the camera.

13. The apparatus of claim 12, wherein the first protocol is different from the second protocol.

14. The apparatus of claim 12, further comprising a user interface coupled to the external camera controller.

15. The apparatus of claim 14, wherein the user interface comprises a display configured to provide visual feedback about the at least one exposure function of the camera being controlled by the one or more first control signals and the one or more second control signals coordinated by the external camera controller.

16. The apparatus of claim 14, wherein the user interface comprises a user input device configured to enable management of the at least one exposure function of the camera being controlled by the one or more first control signals and the one or more second control signals coordinated by the external camera controller.

17. The apparatus of claim 16, wherein the user input device is further configured to initiate at least one aspect of:
a) the output of the one or more first control signals; or
b) the output of the one or more second control signals,
as part of the coordination of the one or more first control signals and the one or more second control signals by the external camera controller to effect control of the at least one exposure function of the camera.

18. The apparatus of claim 12, wherein the external camera controller is further adapted to coordinate the one or more first control signals and the one or more second control signals to effect control of at least one exposure function of the camera by:
utilizing at least one auxiliary camera function control with the one or more first control signals; and
controlling at least one shutter function with the one or more second control signals.

19. The apparatus of claim 18, wherein the at least one auxiliary camera function utilized with the one or more first control signals comprises at least one:
reading a currently set shutter speed;
reading a currently set exposure mode;
setting an internal shutter speed;
disabling internal shutter speed control;
returning a shutter speed to a previously read shutter speed;
returning an exposure mode to a previously read exposure mode;
setting a camera exposure mode;
enabling or disabling autofocus;
adjusting a focus; and
adjusting a lens aperture.

20. The apparatus of claim 18, wherein the at least one shutter function controlled with the one or more second control signals comprises opening a camera shutter.

21. The apparatus of claim 20, wherein the at least one shutter function controlled with the one or more second control signals further comprises moving a mirror out of an image light path prior to opening the camera shutter.

22. The apparatus of claim 21, wherein the at least one shutter function controlled with the one or more second control signals further comprises locking the mirror after moving the mirror out of the image light path.

23. The apparatus of claim 21, wherein the at least one shutter function controlled with the one or more second control signals further comprises pausing between moving the mirror out of the image light path and opening the camera shutter to allow vibrations from the moved mirror to dampen prior to opening the camera shutter.

24. The apparatus of claim 20, wherein the at least one shutter function controlled with the one or more second control signals further comprises closing the camera shutter.

25. The apparatus of claim 24, wherein the at least one shutter function controlled with the one or more second control signals further comprises moving the mirror back into the image light path.

26. The apparatus of claim 12, wherein the apparatus for remotely controlling the camera is handheld.

27. A computer program product for remotely controlling a camera, the computer program product comprising a storage medium readable by a processing circuit and storing instructions for execution by the processing circuit for performing a method of remotely controlling a camera, the method comprising:
externally sending one or more first control signals having a first protocol to a first interface of a camera;
externally sending one or more second control signals having a second protocol to a second interface of the camera different from the first interface; and
coordinating the one or more first control signals and the one or more second control signals to effect control of at least one exposure function of the camera.

28. The computer program product of claim 27, wherein the first protocol is different from the second protocol.

29. The computer program product of claim 27, wherein:
the first interface comprises a universal serial bus (USB) interface; and
the second interface comprises a shutter control interface.

30. The computer program product of claim 27, wherein coordinating the one or more first control signals and the one or more second control signals to effect control of at least one exposure function of the camera comprises:
utilizing at least one auxiliary camera function control with the one or more first control signals; and
controlling at least one shutter function with the one or more second control signals.

31. The computer program product of claim 30, wherein the at least one auxiliary camera function utilized with the one or more first control signals comprises at least one:
reading a currently set shutter speed;
reading a currently set exposure mode;
setting an internal shutter speed;
disabling internal shutter speed control;
returning a shutter speed to a previously read shutter speed;
returning an exposure mode to a previously read exposure mode;
setting a camera exposure mode;
enabling or disabling autofocus;
adjusting a focus; and
adjusting a lens aperture.

32. The computer program product of claim 30, wherein the at least one shutter function controlled with the one or more second control signals comprises opening a camera shutter.

33. The computer program product of claim 32, wherein the at least one shutter function controlled with the one or more second control signals further comprises moving a mirror out of an image light path prior to opening the camera shutter.

34. The computer program product of claim 33, wherein the at least one shutter function controlled with the one or more second control signals further comprises locking the mirror after moving the mirror out of the image light path.

35. The computer program product of claim 33, wherein the at least one shutter function controlled with the one or more second control signals further comprises pausing between moving the mirror out of the image light path and opening the camera shutter to allow vibrations from the moved mirror to dampen prior to opening the camera shutter.

36. The computer program product of claim 32, wherein the at least one shutter function controlled with the one or more second control signals further comprises closing the camera shutter.

37. The computer program product of claim 36, wherein the at least one shutter function controlled with the one or more second control signals further comprises moving the mirror back into the image light path.
